(19) United States
(12) Patent Application Publication
(10) Pub. No.: US 2003/0155442 A1
(43) Pub. Date: Aug. 21, 2003

(54) Fuel-injection valve for internal combustion engines

(76) Inventors: Heinrich Faber, Stuttgart (DE); Friedrich Muehleder, Muehlacker (DE); Thomas Kuegler, Korntal-Muenchingen (DE); Friederike Lindner, Gerlingen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/203,979

(22) PCT Filed: Dec. 7, 2001
(86) PCT No.: PCT/DE01/04622

(30) Foreign Application Priority Data
Dec. 22, 2000 (DE) 100 64 802.9

(51) Int. Cl. F02M 61/00

(52) U.S. Cl. 239/533.12; 239/533.2

(57) ABSTRACT

A fuel injection valve with a valve body (1), whose end oriented toward the combustion chamber is provided with a pressure chamber (26), which is connected to a supply conduit (7). The pressure chamber (26) is defined by a valve member (20) whose valve sealing surface (18) rests against a stationary valve seat (17) with an internal tension and can be lifted up from this valve seat by the pressure in the pressure chamber (26). Downstream of the unblocked opening cross section, there is at least one injection opening (12) into the combustion chamber of the engine. The valve member (20) is embodied as essentially disk-shaped and the valve sealing surface (18) is embodied in its radially outer edge region and can be lifted up from the valve seat (17) in an elastic manner. In its center region, the valve member (20) is prestressed toward its contact with the valve seat (17) by a securing element (22) on the valve body (1) (FIG. 2).

### PRIOR ART

The invention is based on a fuel injection valve for internal combustion engines as known, for example, from the Patent Application DE 195 48 540 A1. The known fuel injection valve is provided with a housing in which a hollow chamber is formed at the combustion chamber end, between a valve body and a sealing plate, and this hollow chamber contains an essentially disk-shaped valve member that divides the hollow chamber into a lower hollow chamber oriented toward the combustion chamber and an upper hollow chamber oriented away from the combustion chamber. A supply bore extends in the valve body, by means of which highly pressurized fuel can be pumped into the lower hollow chamber through a central opening of the valve member. The valve member is connected to the valve body in the region that encompasses the central opening so that the outer edge of the valve member is embodied as elastic. At the outer edge, the valve member rests against the sealing plate so that the lower hollow chamber is sealed off with the exception of the supply bore. At the edge of the upper hollow chamber, an annular, disk-shaped elastic element is provided, which is disposed between the valve body and the outer, elastic edge of the valve member and holds the outer edge of the valve member in contact with the sealing plate. Radially outside the annular contact line of the valve member against the sealing plate, a number of injection openings are disposed in the valve body, which feed into the combustion chamber of the engine. With a corresponding pressure in the lower hollow chamber, the valve member is pressed away from the combustion chamber, counter to its inherent initial tension and counter to the force of the elastic element on the outer edge so that the valve member lifts up from the sealing plate and connects the injection openings to the lower hollow chamber. The opening pressure required for this can be adjusted by means of the thickness of an intermediary disk that is disposed between the elastic element and the valve body. In this connection, the known fuel injection valve, however, has the disadvantage that two elastic components must be provided, namely the valve member itself and the elastic element. The opening pressure of the fuel injection valve, which is critical to the injection, therefore depends on the elasticity of the elastic components and also on the thickness of the intermediary disk and on the precise course of the sealing line of the valve member against the sealing plate. This requires a very precise manufacture and therefore incurs high costs and entails numerous error influence factors.

### ADVANTAGES OF THE INVENTION

The fuel injection valve according to the invention, with the characterizing features of claim 1, has the advantage over the prior art that the entire valve opening function is integrated into only one valve member and one adjusting element, which permits a considerable reduction of costs and possible error influence factors. The valve member is embodied as essentially disk-shaped and is connected to the valve body in a central region. Between the valve body and the valve member, there is a securing element, the axial span of which can be used to simply determine the initial stress of the valve member and therefore the opening pressure at which the outer edge of the valve member lifts up from a counterpart plate. This represents a considerable simplification over the prior art since in the fuel injection valve according to the invention, both the fastening of the valve member and the setting of the opening pressure can be adjusted by means of only one component, namely the securing element.

In an advantageous embodiment of the subject of the invention, the securing element is disposed in a cylindrical recess in the valve body, without requiring the additional connecting element or a glued or welded connection. As a result, the securing element can be easily installed in the valve body and can be easily replaced as needed with a different securing element. Since the initial stress of the valve member is a function of the span of the securing element in the axial direction, the initial tension of the valve member and therefore also the opening pressure can therefore be easily changed.

In another advantageous embodiment, a circumferential annular rib is embodied on the valve member oriented toward the valve seat, with which the valve member rests against the valve seat. This annular rib preferably has a triangular cross section so that a precisely defined sealing edge is produced. By means of this, the surface area of the valve member that is acted on by the pressure in the pressure chamber is precisely defined, which prevents a displacement of the opening pressure due to an altered sealing edge.

Other advantages and advantageous embodiments of the subject of the invention can be inferred from the drawings, the specification, and the claims.

### DRAWINGS

An exemplary embodiment of the fuel injection valve according to the invention is shown in the drawings.

FIG. 1 shows a longitudinal section through the fuel injection valve,

FIG. 2 shows an enlarged depiction of FIG. 1 in the end region oriented toward the combustion chamber, with the valve member disposed there, and

FIG. 3 shows a cross section through the fuel injection valve shown in FIG. 2, along the line III-III.

### DESCRIPTION OF THE EXEMPLARY EMBODIMENT

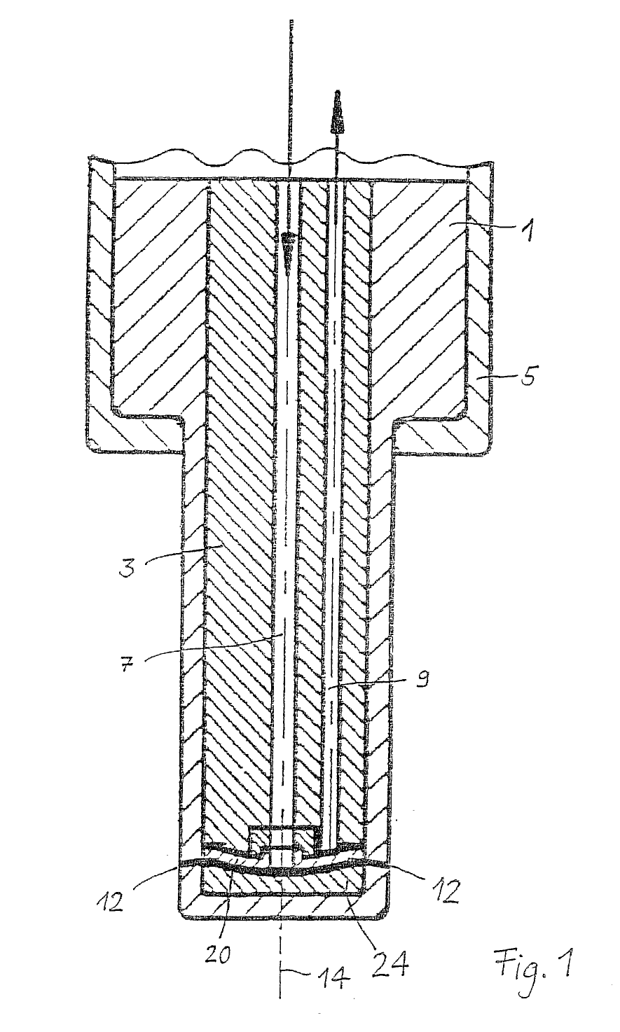

FIG. 1 shows a longitudinal section through a fuel injection valve according to the invention. A shell body 1 is clamped by means of a retaining nut 5 against a securing body that is not shown in the drawing. The shell body 1 contains a valve body 3, which has a longitudinal axis 14 and contains a supply conduit 7 that extends along the longitudinal axis 14. The supply conduit 7 is connected at its supply end to a high-pressure fuel source that is not shown in the drawing so that highly pressurized fuel can be introduced into the supply conduit 7. In addition to the supply conduit 7, the valve body 3 also contains a discharge line 9 so that fuel can flow out through the discharge line 9 into an unpressurized discharge device not shown in the drawing.

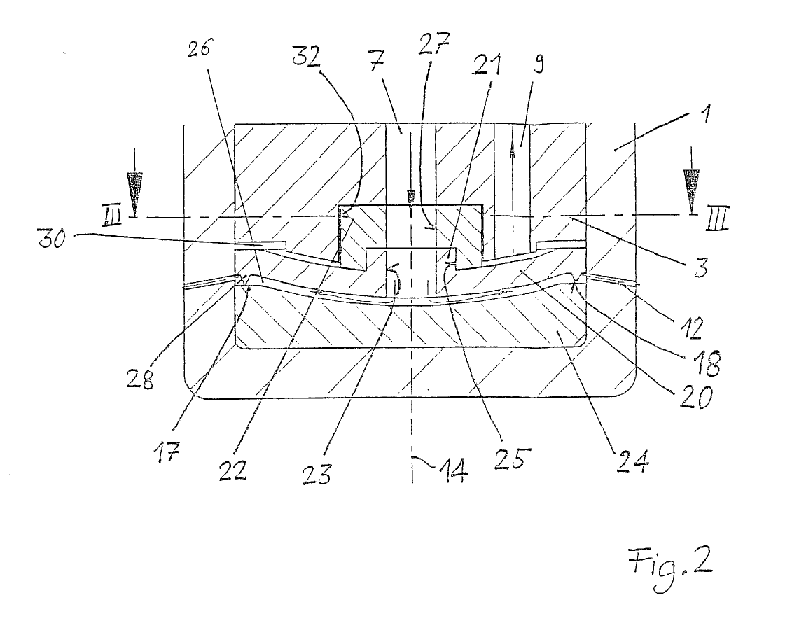

FIG. 2 shows an enlargement of FIG. 1 at the combustion chamber end. A counterpart plate 24 is provided there in the shell body 1 and a valve member 20, which is embodied as essentially disk-shaped, is disposed between this counterpart plate 24 and the valve body 3. The valve member 20 divides the intermediary space between the valve body 3 and the counterpart plate 24 into a pressure chamber 26 and an overflow fuel chamber with 30; the overflow fuel conduit 9 feeds into the overflow fuel chamber 30. On its side oriented toward the valve body 3, the valve member 20 has a securing bolt 21 that is cylindrically embodied and has a central opening 23. The securing bolt 21 is disposed in a receiving opening 25, which is embodied in a securing element 22 disposed between the valve body 3 and the valve member 20. The securing element 22 in this instance is disposed in a recess 32 of the valve body 3 and likewise has a central opening 27 so that the supply conduit 7 extends through the central opening 23 of the securing element 22 and the central opening of the valve member 7 and thus reaches into the pressure chamber 26.

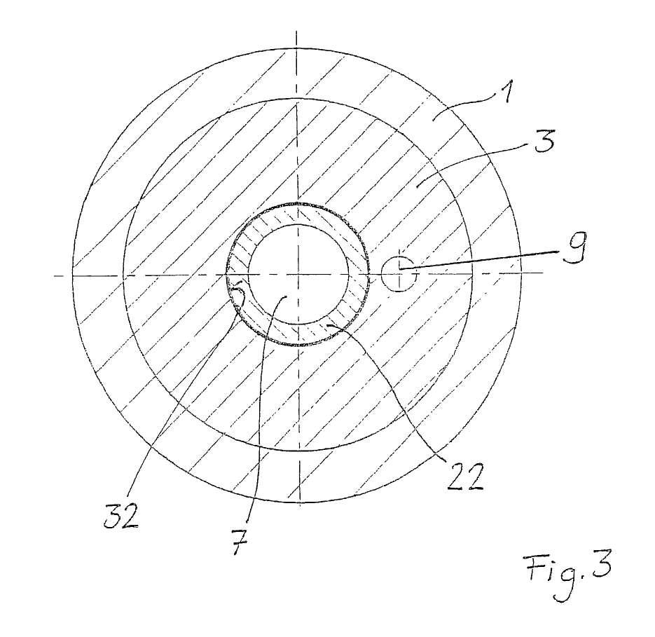

On its side oriented toward the valve body 3, the counterpart plate 24 is curved in a concave fashion so that its outer edges are closer to the valve body 3 than the central region. As a result of this, in the installed position, the securing element 22 presses the securing bolt 21 of the valve member 20 toward the counterpart plate 24; the concave form of the counterpart plate 24 presses the outer edge of the valve member 20 further in the direction of the valve body 3 so that the valve member 20 is mechanically prestressed and is clamped in a stationary fashion against the valve body 3 only in its central region. As a result, the outer edge of the valve member 20 is elastically embodied and can move in the axial direction in relation to the valve body 3, i.e. essentially in the direction of the longitudinal axis 14. At the outer edge of the valve member 20 oriented toward the counterpart plate 24, the valve member 20 is provided with a valve sealing surface 18 with which it rests against a valve seat 17 embodied on the counterpart plate 24 so that the pressure chamber 26 is sealed with the exception of the supply conduit 7. In order to improve the sealing action, the outer edge of the valve member 20 is provided with a circumferential annular rib 28, which has a triangular cross section, and the edge thus formed, which constitutes the sealing surface 18, rests against the valve seat 17. Radially outside the pressure chamber 26, a number of injection openings 12 are embodied in the shell body 1, which feed into the combustion chamber of the engine. FIG. 3 shows a cross section through FIG. 2 along the line III-III and also shows the disposition of the shell element 1 of the valve body 3 and the securing element 22.

The fuel injection valve functions as follows: if an injection of fuel into the combustion chamber of the engine is to take place, highly pressurized fuel is introduced into the pressure chamber 26 by means of the supply conduit 7, the securing element 22, and the central opening 23 of the valve member 20. The fuel pressure produces a hydraulic force on the valve member 20 so that with a sufficient fuel pressure, the outer edge of the valve member 20 with the valve sealing surface 18 lifts up from the valve seat 17 and thus unblocks an opening cross section that connects the injection openings 12 to the pressure chamber 26. Fuel flows out of the central opening 23 into the pressure chamber 26 and in the radial direction to the injection openings 12; the flow direction is indicated with arrows in the drawing. The outer edge of the valve member 20 moves toward the valve body 3 until it is either held by the equilibrium between the hydraulic force and the internal stress or comes into contact with the valve body 3. If the injection is to be terminated, the fuel supply through the supply conduit 7 is discontinued and the fuel pressure in the pressure chamber 26 correspondingly decreases. As soon as the internal stress of a valve member 20 is greater than the hydraulic force on the side of the valve member 20 adjoining the pressure chamber 26, then the outer edge of the valve member 20 moves toward the valve seat 17 again until the valve sealing surface 18 comes into contact with the valve seat 17 and thus closes the pressure chamber 26 off from the injection openings 12.

During the high-pressure phase in the pressure chamber 26, i.e. during the injection, fuel travels past the outer edge of the valve member 20 into the overflow fuel chamber 30. This fuel is carried away via the overflow fuel line 9; the flow direction is indicated by an arrow in FIG. 2. Therefore the overflow fuel chamber 30 remains at a constant low pressure and the opening movement of the valve member 20 is not impaired by the displacement of the fuel in the overflow fuel chamber 30.

The opening pressure, i.e. the precise pressure in the pressure chamber 26 at which the valve member 20 opens and at which fuel is injected into the combustion chamber through the injection openings 12, is extremely important for the vaporization of the fuel when it emerges from the injection openings 12 and therefore for an optimal combustion. In the current fuel injection valve, this opening pressure is chiefly a function of the mechanical initial stress of the valve member 20. This can be easily adjusted by the axial depth of the securing element 22: the thicker the securing element 22 is, the more intensely the valve member 20 is curved in the installation position and therefore the greater the opening pressure of the fuel injection valve is. As a result, the opening pressure can be varied by simply replacing the securing element 22, without the need to replace or adapt other components of the fuel injection valve. The securing element 22 is therefore a turned part that is easy to manufacture, which incurs only minimal costs during production. Since the securing element 22 is pressed into the recess 32 by the mechanical internal stress of the valve member 20, it is not necessary to fasten the securing element 22 to the valve body 3 nor is it necessary to fasten the valve member 20 to the securing element 22. The fuel pressure in the supply conduit 7 and therefore also in the central opening 27 of the securing element 22, which pressure is high at least during the injections, causes the securing element 22 to expand slightly in the radial direction so that it is securely held in the recess 32. In the same manner, the central opening 23 of the valve member 20 expands under high fuel pressure, which generates an additional securing force of the valve member 20 against the securing element 22.

In addition to embodying the annular rib 28 with a triangular cross section, it is also possible to embody the annular rib 28 with a different cross section. For example, the sealing surface 18, which is only very small, can be enlarged somewhat by flattening the annular rib 28, which reduces the surface area pressure and therefore the wear in the region of the valve seat 17. However, a semicircular or rectangular cross section of the annular rib 28 is also possible.

1. A fuel injection valve for internal combustion engines, with a valve body (1), whose end oriented toward the combustion chamber is provided with a pressure chamber (26), which is connected to a supply conduit (7) and is defined by a valve member (20) whose valve sealing surface (18) rests against a stationary valve seat (17) with an internal tension and can be lifted up from this valve seat by the pressure in the pressure chamber (26); downstream of the opening cross section thus unblocked, there is at least one injection opening (12) into the combustion chamber of the engine; the valve member (20) is embodied as essentially disk-shaped and the valve sealing surface (18) is embodied in its radially outer edge region and can be lifted up from the valve seat (17) in an axially elastic manner, characterized in that in its center region, the valve member (20) is prestressed toward its contact with the valve seat (17) by a securing element (22) on the valve body (1).

2. The fuel injection valve according to claim 1, characterized in that the valve member (20) has a centrally disposed securing bolt (21) in which the supply conduit (7) extends and which is contained in a receiving opening (25) of the securing element (22).

3. The fuel injection valve according to claim 1, characterized in that the securing element (22) has a central opening (27) in which the supply conduit (7) extends.

4. The fuel injection valve according to claim 1, characterized in that the securing element (22) is disposed in an essentially cylindrical recess (32) of the valve body (3).

5. The fuel injection valve according to claim 1, characterized in that the valve member (20) has a circumferential annular rib (28) in its outer region, with which it rests against the valve seat (17).

6. The fuel injection valve according to claim 5, characterized in that the annular rib (28) has a triangular cross section; the tip of the triangle is oriented toward the valve seat (17).

7. The fuel injection valve according to claim 5, characterized in that the annular rib (28) has an at least approximately semicircular cross section; the flat side of the semicircle adjoins the valve member (20).
